(19) United States
(12) Patent Application Publication
(10) Pub. No.: US 2007/0299212 A1
(43) Pub. Date: Dec. 27, 2007

(54) Polymer impact modifier blend concentrate

(76) Inventor: Benjamin Andrew Smillie, Kingston (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/049,842

(22) Filed: Feb. 3, 2005

(51) Int. Cl. C08L 67/02; C08L 33/02

(52) U.S. Cl. 525/425; 525/201

(57) ABSTRACT

Polymer impact modifier blend concentrates are provided. The impact modifier blend concentrates are useful to form objects that resist fracturing upon impact, in particular materials that require toughness at low temperatures, such as sports equipment and dual ovenable trays. The impact modifier blend concentrates are polymeric compositions that include a polyester and an ethylene copolymer blend.

### FIELD OF THE INVENTION

The present invention is directed to improving the impact resistance, and in particular the low temperature impact resistance, of certain polymers such as polyesters. Specifically, an impact modifier blend concentrate that can be dried with a bulk polyester is provided.

### BACKGROUND OF THE INVENTION

Several patents and publications are cited in this description in order to more fully describe the state of the art to which this invention pertains. The entire disclosure of each of these patents and publications is incorporated by reference herein.

Polyesters offer many advantageous properties, such as very low water absorption, particularly in comparison to polyamides such as nylons; good dimensional stability; good electrical properties; good resistance to chemical attack and high environmental stress; crack resistance, particularly in comparison to polycarbonates; good heat resistance and heat aging resistance; low creep, even at elevated temperatures; good color stability; and excellent wear properties. Crystalline polyesters offer further advantages, including higher melting temperatures, uniform melting properties, and insolubility in organic solvents.

Accordingly, polyesters are the material of choice for many applications, including packaging, such as beverage containers and packaging for baked goods, frozen foods, and meats; engineering resins; monofilaments; fibers and nonwoven materials; films, including medical imaging and videotape; adhesives; and as a thick sheet for signage and medical packages, for example.

Many polyester applications require superior toughness, that is, the property of resisting fracturing upon impact. Improving the toughness of various polymer compositions is therefore a perennial goal in certain industries, such as the manufacture of sports equipment, dual ovenable trays, automotive parts, and the like. It is therefore known to use an impact modifying additive to provide adequate toughness to polyester resins. Commonly used impact modifiers include styrene block copolymers, acrylic. core/shell particles, and ethylene copolymers such as Elvaloy® PTW and Elvaloy® AC, available from E. I. du Pont de Nemours and Company of Wilmington, Del. (hereinafter “DuPont”).

Improved toughness is also important to polyester recycling processes. It is well known that polyesters may decrease in molecular weight due to hydrolysis during melt processing. The decrease in molecular weight causes degradation of certain mechanical properties, for example toughness. The addition of an impact modifier to recycled polyester during the recycling re-extrusion process counteracts the observed loss in toughness, however.

Disadvantageously, though, many traditional impact modifiers melt at temperatures lower than those at which polyesters are dried prior to melting and extrusion (typically about 150° C.). Thus, pellets of the impact modifier quickly fuse with the polyester pellets at higher temperatures, resulting in clumping in the drying apparatus. Consequently, the use of the traditional impact modifiers requires additional resin handling systems to co-feed the hot dry polyester pellets and the impact modifier pellets at the throat of the sheet extruder, so that the hot polyester pellets are separated from the impact modifier pellets until both types of pellets are at the extruder feed screw. This specialized co-feed arrangement detracts from the economic efficiency of the manufacturing process.

Another additive commonly used in crystalline polyester formulations is the crystallization nucleant. When the polyester is in the amorphous or glassy form, the crystallization nucleant reduces the temperature at which the amorphous polyester will crystallize. Crystallization nucleants generally used in the art, such as polyethylene, waxes, and inorganic particles, including talc, silica (SiO₂), titania (TiO₂), and the like, are disadvantageously prone to create deposits in molds, however.

One use for polyesters that presents particular challenges is the fabrication of dual-ovenable trays. These trays, which are typically formed principally of crystalline polyethylene terephthalate (CPET), are used to freeze, transport, and store food items. The food items, still in the dual-ovenable trays, are then heated in a microwave or conventional oven to a temperature that is safe for consumption. Thus, a dual-ovenable tray must resist shattering on impact over a broad range of temperatures, generally about −40° C. to about 200° C. The materials in a dual-ovenable tray must be safe for direct contact with food, and they must maintain dimensional stability on heating. In addition, both the materials and the processes used to fabricate dual-ovenable trays must be economically favorable.

Injection molding and thermoforming are widely known methods for forming thermoplastic polyester articles. In injection molding, the polyester is heated above its melting point and injected under sufficient pressure to force the molten polyester to fill the mold cavity. The molten polyester is cooled in the mold until it is rigid enough to be removed. The injection molding method is generally not satisfactory, however, for the production of thin walled articles, such as dual-ovenable trays, due to flow lines and layering that may develop during the filling of the mold and that may lead to non-uniform properties, surface irregularities, and warping of the finished article. Moreover, very high filling pressures are typically required in the injection molding of thin walled articles, due to high melt viscosities.

Thermoforming is another commercial process that is used in the production of polyester articles. It is a particularly valuable technique for producing thin walled articles, such as dual ovenable food trays. In thermoforming, cast polyester sheet is preheated to a temperature sufficient to allow the deformation of the sheet. This temperature may be well below the melting point of the polyester. The sheet is then conformed to the contours of a mold by such means as vacuum assist, air pressure assist, or matched mold assist. The thermoformed article thus produced is normally heat treated in the mold in order to increase the crystallinity of the polyester.

In this connection, Thermoforming by J. L. Throne, Hansler (N.Y., 1986) provides a comprehensive overview of techniques including CPET thermoforming. The Encyclopedia of Polymer Science and Engineering, Wiley Interscience (New York, 1989), in Vol. 16 at page 823, describes the CPET thermoforming process from the glassy state. In addition, U.S. Pat. No. 6,576,309, issued to Dalgewicz, III et al., describes thermoplastic compositions that are useful in food grade applications such as dual ovenable containers. Also, U.S. Pat. No. 5,747,127, issued to Prince, describes a thermoplastic resin composition that is suitable for use in thermoforming thin walled articles such as dual ovenable trays. Finally, GB Pat. No. 1 222 223, issued to Farbwerke Hoechst Aktiengesellschaft, describes methods to improve the toughness and crystallization rate of aromatic polyester based molding compositions. Each of these patents also includes a description of one or more of the “melt to mold” process or CPET thermoforming from the amorphous or glassy state.

In summary, there are many useful applications that benefit from the availability of tougher polymers, and in particular polymers with superior low temperature impact resistance. Consequently, it will be appreciated that an ongoing need exists for improved means of imparting impact resistance to polymeric materials.

### SUMMARY OF THE INVENTION

A new impact modifier blend concentrate composition that can be dried with a bulk polyester has now been found in the present invention.

Accordingly, in a first aspect, the invention provides an impact modifier blend concentrate composition comprising a polyester and an ethylene copolymer blend.

In a second aspect, the invention provides a method of making an impact resistant polyester. The method includes providing an impact modifier blend concentrate of the invention, and blending the impact modifier blend concentrate with at least one bulk polyester. In some embodiments, the impact modifier blend concentrate is blended with the bulk polyester, and the resulting pellet blend is dried. The bulk polyesters may be new or recycled materials.

In accordance with another aspect of the invention, a method of improving the impact resistance of an article is provided. The method includes incorporating the IMPACT MODIFIER BLEND CONCENTRATE of the invention into the article.

In accordance with another aspect of the invention, an object comprising the impact modifier blend concentrate of the invention is provided.

Advantageously, the impact modifier blend concentrate of the invention provides a convenient and economical means to improve the impact resistance of polyesters and articles fabricated with polyesters, in particular their low temperature impact resistance. Also, the use of the impact modifier blend concentrate provides certain advantages in the process of making impact resistant polyesters by melt extrusion.

First, in general, no clumping results when the impact modifier blend concentrate is blended with one or more polyesters in the desiccant hopper of an extruder under typical polyester drying conditions. In addition, the impact modifier blend concentrate promotes crystallization of the impact resistant polyester due to the nucleating effect of the ionomer compatibilizer.

### DETAILED DESCRIPTION OF THE INVENTION

The definitions herein apply to the terms as used throughout this specification, unless otherwise limited in specific instances.

The terms “finite amount” and “finite value” refer to an amount that is not equal to zero.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In one embodiment, the present invention provides an impact modifier blend concentrate composition comprising a polyester and an ethylene copolymer blend.

Suitable polyesters for use in the present invention include, without limitation, poly(ethylene terephthalate) (PET); PET modified by incorporating diacids other than terephthalic acid, such as isophthalic acid, or glycols other than ethylene glycol, such as 1,3-propanediol, diethylene glycol or cyclohexane dimethanol; copolymers containing terephthalic acid, cyclohexane dimethanol, 1,3-propanediol, diethylene glycol and other dibasic acids, such as isophthalic acid; poly(ethylene napthalate); copolyesters thereof; combinations, e.g., blends, thereof; and derivatives thereof. Among the preferred polyesters are PET, blends thereof, and derivatives thereof.

The polyester may be recycled or virgin material. The term “recycled polyester”, as used herein, refers to any polyester resin that has been previously extruded, for example into a sheet, or molded, for example by injection molding. Recycled polyester may be collected from any source, such as, for example, post consumer recycle streams, in-house operations at a manufacturing facility, and the like. Examples of recycled polyester include, without limitation, trim scrap, edge trim, chopped up polyester bottles and trays, and the like.

The preferred polyesters are also thermoplastic and crystallizable, having a glass transition temperature (T_{g}) of at least 50° C., and a melting point of at least 150° C. More preferred polyesters have a melting point of at least 200° C., and still more preferably at least 250° C. Typically, for packaging applications, the color of the crystallized polyester should be very white and opaque.

Preferred polyesters are also characterized by a molecular weight adequate to obtain desired flexural characteristics. In particular, the intrinsic viscosity (IV) is preferably at least about 0.5 as measured in a 1:1 weight:weight solution of methylene chloride and trifluoroacetic acid. Preferably, the intrinsic viscosity is at least about 0.65, and more preferably at least about 0.85 or about 0.95.

Methods of preparing polyesters are well known in the art. See, for example, the Modern Plastics Encyclopedia, McGraw Hill, (New York, 1994); and the Wiley Encyclopedia of Packaging Technology, 2d edition, A. L. Brody and K. S. Marsh, Eds., Wiley-lnterscience (Hoboken, 1997). Briefly, polyesters are generally synthesized from aromatic dicarboxylic acids, and preferably the lower alkyl esters thereof, such as the dimethyl ester of terephthalic acid. The aromatic dicarboxylic acid or its ester or anhydride may be esterified or trans-esterified and polycondensed with a saturated diol such as ethylene glycol. Typically used saturated diols include saturated aliphatic or cycloaliphatic diols, preferably the lower alkane diols, such as ethylene glycol. Mixtures of aliphatic carboxylic acids and saturated diols may also be used, provided that the above-described physical properties, i.e., melting point and T_{g} ranges, are generally obtained.

Several preferred grades of polyester for use in the present invention are commercially available. These include high molecular weight PET homopolymers with intrinsic viscosities of 0.85 or higher, such as Futura™ NP 107, available from Futura Polymers Ltd. of Chennai, Tamil Nadu, India, and Crystar® 5005, available from DuPont.

The amount of polyester in the impact modifier blend concentrate preferably ranges up to about 75 wt %, more preferably from about 40 to about 75 wt %, and still more preferably from about 55 to about 70 wt %, based on the total weight of the impact modifier blend concentrate.

The impact modifier blend concentrate of the invention also comprises an ethylene copolymer blend. Preferably, the amount of ethylene copolymer blend in the impact modifier blend concentrate ranges from greater than about 25 wt %, more preferably from about 25 to about 60 wt %, and still more preferably from about 30 to about 45 wt %, based on the total weight of the impact modifier blend concentrate.

It is generally preferable to maximize the loading of the ethylene copolymer blend in the impact modifier blend concentrate while maintaining the polyester as the continuous phase. Maximizing the loading of ethylene copolymer blend minimizes the amount of concentrate required to achieve the desired toughness in the finished polyester or article. Maintaining the polyester as the continuous phase ensures that the impact modifier blend concentrate does not agglomerate during the high temperature processing steps, such as drying the concentrate with a bulk polyester prior to extrusion. This is believed to be the result of the morphology of the impact modifier blend concentrate blend, specifically, the lower melting ethylene copolymer phase being dispersed in the continuous polyester phase.

In this connection, it has now surprisingly been found that the ethylene copolymer phase of the impact modifier blend concentrate need not have a small particle size or even particulate morphology in order to provide a polyester blend whose impact modifier has the preferred particulate morphology. Accordingly, it is preferred but not necessary that the ethylene copolymer phase have particulate morphology.

The ethylene copolymer blend comprises a copolymer of ethylene and an alkyl acrylate, a compatibilizer comprising an ionomer, and, optionally, a crosslinking agent. Any known ethylene alkyl acrylate copolymer, whether prepared by an autoclave or tubular process, is suitable for use in the ethylene copolymer blend.

The alkyl group of the acrylate ester may be a straight chain or branched group having from one to ten carbon atoms. Preferred alkyl groups include methyl, ethyl, and butyl groups, and combinations of two or more of these groups are also preferred. Combinations including methyl groups are more preferred.

Still more preferably, the alkyl acrylate consists essentially of methyl acrylate. U.S. Patent Appln. Pub. No. 2004/0006180 by Trouilhet et al. describes various copolymers of ethylene and methyl acrylate, and uses thereof. In the present invention, the methyl acrylate comonomer content is preferably greater than about 10 wt %, based on the weight of the ethylene methyl acrylate (EMA) copolymer. More preferably, the methyl acrylate comonomer content is greater than about 15 wt %, and, still more preferably, the methyl acrylate comonomer content is greater than about 25 wt %, based on the weight of the EMA copolymer. For uses that require direct contact with food, however, such as the dual ovenable tray, applicable food packaging guidelines may limit the total fraction of methyl acrylate in the EMA copolymer to less than 25 wt %.

The melt flow index (MFI or 12) of the ethylene alkyl acrylate copolymers, measured according to ASTM D1238 at conditions of 190° C. and under a weight of 2.16 kg, may range up to about 10 g/10 min; however, as those of skill in the art are aware, an MFI of the EMA copolymer that corresponds to the viscosity. of the polyester will be preferred. It is well known that a dispersed phase is more easily developed in a continuous phase when the viscosity ratio of the dispersed and continuous phases is near unity. See Dealy J. M., Wissburn K. F. Melt Rheology and its Role in Plastic Processing, Van Nostrand Reinhold (New York, 1990). Accordingly, the MFI of the ethylene alkyl acrylate copolymer is preferably less than about 4.0 g/10 min, 2.0 g/10 min, 1.0 g/10 min, 0.5 g/10 min, or 0.3 g/10 min, with increasing preference in the order given.

In general, tubular grades of ethylene acrylate copolymers have higher melting temperatures at the same weight fraction of acrylate, compared to ethylene acrylate copolymers prepared by the autoclave process. As noted above, higher melting ethylene acrylate copolymers are preferred. Therefore, ethylene alkyl acrylate copolymers that are prepared in a tubular reactor are also preferred.

Several preferred ethylene alkyl acrylate copolymers for use in the present invention are commercially available. These include Elvaloy® AC tubular grade EMA copolymers, available from DuPont. Autoclave produced grades of ethylene acrylate copolymers are sold by the ExxonMobil Chemical Company of Houston, Tex., under the Optema™ brand name.

Methods of preparing EMA copolymers are well known in the art. See, for example, the Modern Plastics Encyclopedia and the Wiley Encyclopedia of Packaging Technology.

The amount of ethylene alkyl acrylate copolymer in the ethylene copolymer blend ranges from about 20 to about 60 wt %, more preferably from about 20 to about 50 wt %, and still more preferably from about 20 to about 36 wt %, based on the total weight of the impact modifier blend concentrate.

The ethylene copolymer blend also includes a compatibilizer that comprises at least one ionomer. The term “ionomer” as used herein, alone or in derivative form, such as “ionomeric”, e.g., refers to an acid copolymer that has been at least partially neutralized with a neutralizing agent such as an inorganic base, and that comprises carboxylate salts with counterions derived from the neutralizing agent.

Suitable ethylene acid copolymers that are precursors for ionomers may be selected from a wide variety of polymers that incorporate ethylene as the basic monomeric unit, and that incorporate at least one comonomer selected from vinyl acetate, acrylic acid, and methacrylic acid. Additional comonomers may also form part of the polymeric structure, and these may be selected from esters such as alkyl acrylates and the like. The alkyl acrylates may be selected from methyl acrylate, ethyl acrylate, n-butyl acrylate, and iso-butyl acrylate. The use of copolymers including acrylate esters of two or more alkyl groups is specifically contemplated.

A common feature of the non-ethylene monomers is the presence of a carboxylic acid moiety or a precursor to such moiety. Additional acid containing comonomers may be selected from ethylenically unsaturated diacids, such as maleic and fumaric acids and their anhydrides. The acid containing comonomer may comprise up to fifty percent of the copolymer. Methods of preparing suitable ethylene acid copolymers are disclosed in, for example, U.S. Pat. Nos. 3,264,272; 3,404,134; 3,355,319 and 4,321,337.

Preferred thermoplastic ethylene acid copolymers are selected from copolymers of ethylene and about 2 to about 50%, more preferably about 5 to about 25%, by weight of acrylic or methacrylic acid. The melt index of the copolymer is preferably about 0.1 to 30, more preferably about 0.5 to 20 dg/min, according to ASTM standard D1238.

Ionomers suitable for use in the present invention may comprise any feasible cation or combination of cations. Preferred cations may be monovalent or divalent. When the cations are metal cations, they are preferably selected from among alkali metals (Group 1), alkaline earth metals (Group 2), transition metals (Groups 3 through 12), lanthanides, and actinides. Preferred cations include lithium, sodium, potassium, magnesium, calcium, barium, copper, zinc, ammonium, or a combination of two or more of these cations. Sodium, potassium, and zinc are more preferred cations for use in the present invention. The sodium cation is particularly preferred. The extent of neutralization of the acid groups by the cation is greater than 36 mol % and preferably greater than 50 mol %.

Also preferably, the molecular weight of the ionomer is sufficiently high so that the viscosity of the ionomer is approximately equal to the viscosity of the polyester. For the same reason, the ionomer (viscosity after neutralization) should have a melt flow index (MFI) at 190° C. and 2.16 kg wt of less than 2 is preferred, and an MFI less than 1 is more preferred. Several preferred ionomers and acid precursors to preferred ionomers can be obtained commercially from DuPont. For example, BYNEL® and NUCREL® are ethylene acrylic or methacrylic acid copolymers optionally containing an additional softening monomer such as an alkyl acrylate; and the SURLYN®) line includes ionomers of certain of the above ethylene acid copolymers or terpolymers. In addition, Himilan™ ionomers are available from Mitsui-DuPont Polychemicals Co., Ltd., of Tokyo, Japan.

Methods of preparing ionomers are described in U.S. Pat. No. 3,344,014, issued to Rees, for example.

The amount of ionomer in the ethylene copolymer blend is preferably a finite amount of from about 0 to about 30 wt %, more preferably from about 2 to about 20 wt %, and still more preferably from about 5 to about 10 wt %, based on the total weight of the impact modifier blend concentrate.

The ionomer, especially a sodium or potassium containing ionomer, is also believed to function as a crystallization nucleant in the impact modifier blend concentrate. See, e.g., U.S. Pat. No. 4,753,980, issued to Deyrup. That is, because of the ionomer, the blend of impact modifier blend concentrate and bulk polyester typically crystallizes more rapidly from the melt or from the glassy state. Moreover, certain blends according to the invention have been measured to crystallize from the glassy or amorphous state at temperatures about 10° C. lower than unmodified polyesters.

The impact modifier blend concentrate of the invention may optionally include one or more crosslinking agents. Any agent known to crosslink an ethylene alkyl acrylate copolymer is suitable for use in the present invention. Preferably, the crosslinking agent is an organic peroxide compound or an organic compound with two or more double bonds. Examples of preferred crosslinking agents include, without limitation, diethylene glycol diacrylate, diethylene glycol dimethacrylate, ethylene glycol dimethacrylate, N,N′-m-phenylene dimaleimide, polyethylene glycol dimethacrylate, triallyl cyanurate, triallylisocyanurate, trimethylolpropane trimethacrylate, tetraallyloxyethane, tetramethylene diacrylate, 2,5-dimethyl-2,5-di-(t-butylperoxy)hexyne-3, t-butyl peroxybenzoate, 2,5-dimethyl-2,5-di-(t-butylperoxy)-2,5-dimethylhexane, dicumyl peroxide, α,α-bis(t-butylperoxy)-2,5-dimethylhexane, and the like.

Particularly preferred crosslinking agents include diethylene glycol diacrylate; diethylene glycol dimethacrylate; ethylene glycol dimethacrylate; 2,5-dimethyl-2, 5-di-(t-butylperoxy)hexyne-3; and 2,5-dimethyl-2,5-di-(t-butylperoxy)hexane.

In certain preferred embodiments, the crosslinking agent includes both an organic peroxide compound and an organic compound with two or more double bonds. Of note are ethylene copolymer blends including both diethylene glycol dimethacrylate and 2,5-dimethyl-2,5-di-(t-butylperoxy)hexane.

Several preferred crosslinking agents for use in the present invention are commercially available. These include Sartomer™ 231 (diethylene glycol dimethacrylate), available from Sartomer Company, Inc., of Exton, Pa., and Luperox™ 101 (2,5-dimethyl-2,5-di(tert-butylperoxy)hexane), available from Atofina Chemicals, Inc., of Philadelphia, Pa.

The crosslinking agent(s), when used, are preferably present in a finite amount of up to about 2%, more preferably a finite amount up to about 1%, and still more preferably in a finite amount up to about 0.4 wt %, based on the total weight of the impact modifier blend concentrate.

Preferably, the impact modifier blend concentrate also includes a stabilizer, such as, e.g., pentaerythritol tetrakis(3-(3,5-di-tert-butyl-1,4-hydroxyphenyl)propionate, which is available under the trade name Irganox™ 1010 from Ciba Specialty Chemicals of Basel, Switzerland. The stabilizer may be present at a level of from 0.0001 to about 5 wt %, about 0.001 to about 4 wt %, about 0.01 to about 3 wt %, or about 0.1 to 2 wt %. The stabilizer is preferably present at a level of about 1% based on the total weight of the impact modifier blend concentrate.

The impact modifier blend concentrate may also include such additives as are conventional in polymer compositions, for example, antioxidants, UV stabilizers, flame retardants, plasticizers, pigments, fillers, reinforcements, processing aids, and the like. Suitable levels of these additives and methods of incorporating these additives into polymer compositions are known to those of skill in the art. See, e.g., Modern Plastics Encyclopedia.

The impact modifier blend concentrate composition of the invention may be made by blending the individual components by any suitable means known in the art. For example, the individual materials can be mixed with each other in molten form, such as by melt blending in an extruder. Alternatively, the individual materials can be blended with each other in a high shear mixing device, such as a two-roll mill or a Banbury mixer.

In some preferred embodiments, the ethylene alkyl acrylate copolymer is crosslinked in situ in an extruder. Crosslinking increases the molecular weight and thereby decreases the MFI of the ethylene alkyl acrylate. Preferred crosslinking agents and preferred levels of crosslinking agents are as set forth above. Preferred conditions for the in situ crosslinking include polymer melt temperatures not exceeding 265° C. and more preferably not exceeding 260° C. Higher melt temperatures tend to promote chain scission of the ethylene acrylate copolymer rather than the intended crosslinking reaction.

In one preferred method, an impact modifier blend concentrate is made by first extruding the ethylene alkyl acrylate copolymer with a small amount of crosslinking agent in a twin-screw extruder to reduce the melt index, preferably to about 0.3 MI. In a second extrusion step, dried polyester resin is co-fed to the throat of a twin-screw extruder along with an ionomer, the crosslinked ethylene alkyl acrylate copolymer, and an antioxidant. These raw materials are processed in the extruder using high screw speed to prepare the impact modifier blend concentrate.

Also provided by the invention are methods of making impact resistant polyesters. In these methods, an impact modifier blend concentrate of the invention is provided, and the impact modifier blend concentrate is combined with at least one bulk polyester. The resulting polymer blend will have an impact resistance that is greater than that of the unmodified bulk polyester.

The preferred bulk polyesters are those described above as suitable for use in the impact modifier blend concentrate. The bulk polyester may be the same as or different from the polyester in the impact modifier blend concentrate. The impact modifier blend concentrate may be combined with a combination of two or more bulk polyesters. Moreover, the bulk polyester may include recycled polyester.

Preferably, the impact modifier blend concentrate and the bulk polyester are dried prior to being combined. The drying may be carried out in a dessicant hopper dryer. In certain preferred embodiments, the impact modifier blend concentrate and bulk polyester can be blended as pellets prior to drying or co-fed into the melt mixing device after drying.

The dried impact modifier blend concentrate and the dried bulk polyester may be combined by any means known in the art. Preferably, they are combined by a melt mixing process such as, e.g., single screw extrusion, twin-screw extrusion or Banbury batch mixing. Single screw extrusion is a preferred method of combining the impact modifier blend concentrate and the bulk polyester.

Preferably, the impact resistant polyester includes at least 10 wt % of the impact modifier blend concentrate, based on the total weight of the impact resistant composition. More preferably, the impact resistant polyester includes about 20 wt % to about 30 wt % of the impact modifier blend concentrate, based on the total weight of the impact resistant composition. Also preferably, the impact modifier in the impact resistant polyester has a particulate morphology. More preferably, the size of the dispersed impact modifier particles is less than about 2 μm, and still more preferably less than or equal to about 1 μm.

Also provided by the present invention are articles comprising the impact modifier blend concentrate of the invention. Such articles may be made according to methods that are well known in the art. For example, after mixing the components of an impact resistant composition, including the impact modifier blend concentrate, in an extruder, the impact resistant composition extruded through a flat die and cast onto a forming drum to form a tray. Alternatively, after mixing the components of an impact resistant composition, including the impact modifier blend concentrate, in an extruder, the impact resistant composition is extruded through a flat die and cast onto a chilled roll to rapidly quench the sheet to prepare amorphous impact resistant sheet that can subsequently be thermoformed to make various articles. Thermoforming is the preferred method of forming articles according to the invention.

The impact resistant composition may be used alone, or it may be used in combination with other materials, such as reinforcing fillers or blowing agents, to form impact resistant articles. Replacing even a portion of material in a conventional article with an impact resistant composition is expected to enhance the impact resistance of the article. Preferably, the impact resistant composition includes at least 10 wt % of the impact modifier blend concentrate, based on the total weight of the impact resistant composition. More preferably, the impact resistant composition includes about 20 wt % to about 30 wt % of the impact modifier blend concentrate, based on the total weight of the impact resistant composition. Also preferably, the impact modifier in the impact resistant article has a particulate morphology. More preferably, the size of the dispersed impact modifier particles is less than about 2 μm, and still more preferably less than or equal to about 1 μm.

Examples of suitable articles whose impact resistance may be increased by at least partial fabrication from an impact resistant composition comprising the impact modifier blend concentrate of the invention include, without limitation, sports equipment, dual ovenable trays, automotive parts, shipping containers, construction materials, furniture, cabinetry, decorative objects, cups, bowls, bakery trays and lids, and the like. Dual ovenable trays are preferred articles according to the invention.

The present invention also provides a method of improving the impact resistance of an article, and an article obtainable by this method. In this method, an impact modifier blend concentrate of the invention is combined with a bulk polyester. The resulting blend is formed into an article by any suitable method known in the art, such as, for example, those described above with respect to other articles according to the invention. The resulting article has an impact resistance that is greater than that of an article fabricated from an unmodified bulk polyester. Replacing even a portion of the polyester in a conventional article with an impact resistant composition of the invention is expected to enhance the impact resistance of the article.

The suitable and preferred bulk polyesters are those described above for use in the impact modifier blend concentrate. The suitable and preferred means and conditions of combining the impact modifier blend concentrate and the bulk polyester are as set forth above with respect to the methods of making impact resistant polyesters. The suitable and preferred articles, the suitable and preferred means of fabricating the articles, and the suitable and preferred levels of impact modifier blend concentrate in the articles, are as set forth above with respect to articles comprising the impact modifier blend concentrate of the invention.

The following examples are provided to describe the invention in further detail. These examples, which set forth a preferred mode presently contemplated for carrying out the invention, are intended to illustrate and not to limit the invention.

### EXAMPLES

### Comparative Examples

Using the conditions and equipment outlined in Appendix 4, below, a sheet (nominally 0.8 mm thick) was cast from NP 107, a PET homopolymer with 0.95 IV available from Futura Polymers. This sheet is Comparative Example 1. Using the same conditions and equipment, a sheet (nominally 0.8 mm thick) was cast from a blend comprising 90 wt % dried NP 107 and 10 wt % Elvaloy® CT-2. Unlike the conditions described in Appendix 4, the Elvaloy® CT-2 was not dried prior to extrusion with the PET. Before blending the Elvaloy® CT-2 with the PET it was necessary to allow the PET to cool to less than the melting point of the ethylene copolymer to prevent clumping during pellet blending or clumping in the extruder hopper. Elvaloy® CT-2 is a pre-extruded blend of Elvaloy® 1224AC and Surlyn® 8920 in a 5:1 wt:wt ratio. This sheet is Comparative Example 2.

The sheet samples were annealed at 140° C. for three hours to promote crystallization, then conditioned overnight at −40° C. prior to dart drop testing according to ASTM D5628 geometry FA. The average F50/25 μm normalized failure weight for sheets of Comparative Example 1 was 1 gm/25 μm at −40° C. The average F50/25 μm normalized failure weight for sheets of Comparative Example 2 was 15 g/25 μm.

Scanning electron microscopy (SEM) analysis of the sheet samples reveal that the unmodified polyester of Comparative Example 1 is a single phase, and that the ethylene copolymers in Comparative Example 2 form a relatively uniformly dispersed particulate phase with particle sizes ranging from less than 0.5 μm to about 2 μm, and with occasional particles as large as about 4 μm.

These data demonstrate that polyester, without an impact modifier, is very brittle. Moreover, the impact resistance of polyester can be significantly improved by the addition of 10 wt % ethylene copolymer.

### Example Set 1

Blends of a polyester and various ethylene copolymers and ionomers were prepared as described below in Appendix 1. The compositions of the blends are set forth in Table 1.

TABLE 1
Impact Modifier Blend Concentrate Compositions

| Example | | | | | | | Processing |
|---|---|---|---|---|---|---|---|
| No. | Polyester | Terpolymer | Ionomer | EMA 1 | EMA 2 | AO | Notes |
| 1 | 84% | 0% | 0% | 15% | 0% | 1% | poor |
| 2 | 84% | 0% | 0% | 0% | 15% | 1% | poor |
| 3 | 80% | 4% | 0% | 15% | 0% | 1% | poor |
| 4 | 76% | 4% | 4% | 0% | 15% | 1% | acceptable |
| 5 | 72% | 4% | 0% | 0% | 23% | 1% | acceptable |
| 6 | 80% | 4% | 0% | 15% | 0% | 1% | poor |
| 7 | 72% | 0% | 4% | 0% | 23% | 1% | acceptable |
| 8 | 68% | 4% | 4% | 23% | 0% | 1% | poor |
| 9 | 72% | 0% | 4% | 0% | 23% | 1% | acceptable |
| 10 | 68% | 4% | 4% | 0% | 23% | 1% | acceptable |
| 11 | 80% | 0% | 4% | 15% | 0% | 1% | acceptable |
| 12 | 76% | 4% | 4% | 0% | 15% | 1% | acceptable |
| 13 | 76% | 0% | 0% | 23% | 0% | 1% | poor |
| 14 | 76% | 2% | 2% | 9.5% | 9.5% | 1% | acceptable |
| 15 | 72% | 4% | 0% | 23% | 0% | 1% | poor |
| 16 | 80% | 4% | 0% | 0% | 15% | 1% | acceptable |
| 17 | 80% | 0% | 4% | 0% | 15% | 1% | acceptable |
| 18 | 72% | 0% | 4% | 23% | 0% | 1% | poor |
| 19 | 89.7% | 1.7% | 0% | 8.3% | 0% | 0.3% | acceptable |

Notes for Table 1: The polyester is NP 107, a PET homopolymer whose intrinsic viscosity is nominally 0.95, supplied by Futura Polymers. The terpolymer is Bynel® 2002 with MI=10. The ionomer is Surlyn® 8920, 0.9 MI sodium counterion. EMA 1 is Elvaloy® 1224AC, an ethylene methyl acrylate copolymer (24 wt % MA) with MI=2. EMA 2 is Elvaloy® 1125AC, an ethylene methyl acrylate copolymer (25 wt % MA) with MI=0.4. The antioxidant (AO) is Irganox™1010.

The Processing Notes in Table 1 refer to the presence or absence of surging or strand breaks at the die. Strand breaks and surging are unacceptable because they lead to material losses and non-uniform pellet cutting. It can be concluded from the data in Table 1 that grades of EMA with lower melt indices (MI) produce more uniform pellets and minimize strand breaks. Furthermore, even at the lowest melt index (0.4 MI), an ionomer or terpolymer compatibilizer is required to prevent strand breaks or surging.

### Example Set 2

The melt viscosity of the Futura NP107 polyester and the EMA copolymers were measured at 280° C. according to ASTM D3835 using a GALAXY V Model 8052 melt rheometer, available from Kayeness, Inc., of Morgantown, Pa. The capillary die geometry was 1.52 mm in diameter and 23 mm in length. The NP 107 resin was dried overnight at 125° C. in a stream of dry nitrogen gas prior to measuring its viscosity. Upon removing the sample from the drier, the sample was immediately charged to the rheometer. There the sample was allowed to melt in the rheometer barrel for five minutes under a preload force of 1100 N before initiating a series of ram extrusion rates that developed shear rates from 10.3 to 1006.7 (1/s). In addition to the NP 107 resin, samples of EMA were also processed through the rheometer, without drying. The melt viscosity values the NP 107 resin and the EMA copolymers are included in Table 2.

TABLE 2
Viscosity (PaS) at 280° C.

| | 1006.7 | 501.6 | 250.8 | 51.5 | 20.6 | 10.3 |
|---|---|---|---|---|---|---|
| Futura NP | 503 | 726 | 964 | 1431 | 1659 | 1738 |
| 107 | | | | | | |
| EMA 1 | 78 | 107 | 148 | 271 | 342 | 429 |
| EMA 2 | 123 | 174 | 246 | 516 | 783 | 956 |
| EMA 3 | 83 | 140 | 170 | 321 | 463 | 609 |

Note: The column headings are the shear rates (1/s).

From the data in Table 3, it is apparent that reducing the melt index of the EMA from 2 to 0.8 to 0.4 brings the viscosity of EMA closer to that of the PET. As is noted above, a viscosity ratio close to unity favors the formation of a dispersed phase.

### Example Set 3

A second series of impact modifier blend concentrates were prepared on a 43 mm 48/1 UD twin-screw extruder. The melt exiting the die of the extruder was cut into pellets using a Gala Industries underwater pelletizer. The polyester was dried overnight at 130° C. in a dessicant hopper drier prior to extrusion. The compositions of these impact modifier blend concentrates are listed in Table 3, below. The extrusion conditions are set forth in detail in Appendix 3, below.

To increase the viscosity and reduce the melt index of the ethylene copolymer, a blend of Elvaloy® AC1224 and an organic peroxide (Lubertex™ 101) was also extruded using the 43 mm twin screw extruder. It was found the addition of nominally 0.35 wt % Luperox to Elvaloy® AC1224 reduced the MI of the EMA from 2 g/10 min to 0.8 g/10 min. The resulting crosslinked EMA is designated “EMA 3” in Table 3 below. The process conditions used to produce EMA 3 are set forth in detail in Appendix 2, below.

TABLE 3
Impact Modifier Blend Concentrate Compositions

| | | | | | | | Ratio of |
|---|---|---|---|---|---|---|---|
| Example | Poly- | EMA | EMA | | Ter- | | EMA/ |
| No. | ester | 2 | 3 | Ionomer | polymer | AO | Compa |
| 20 | 61% | | 32% | 6.4% | | 0.7% | 5.0 |
| 21 | 55% | | 37% | 7.4% | | 0.9% | 5.0 |
| 22 | 50% | | 41% | 8.2% | | 1.0% | 5.0 |
| 23 | 67% | | 27% | 5.4% | | 0.6% | 5.0 |
| 24 | 66% | 24% | | 4.2% | 4.2% | 1.1% | 2.9 |
| 25 | 52% | 34% | | 6.0% | 6.0% | 1.5% | 2.9 |
| 26 | 40% | 43% | | 7.5% | 7.5% | 1.9% | 2.9 |
| 27 | 67% | 27% | | 5.4% | | 1.0% | 5.0 |
| 28 | 52% | 39% | | 7.8% | | 1.4% | 5.0 |
| 29 | 68%* | 23% | | 4.0% | 4.0% | 1.0% | 2.9 |

Notes for Table 3: The polyester is Futura NP 107, except for Example 29, in which the polyester is Crystar® 5005, available from DuPont, a PET homopolymer with IV=0.85. The ionomer, terpolymer, EMA 2, and antioxidant (AO) are as defined above. In the last column of Table 3 the ratio of EMA to Compatibilizer is calculated. In the case of example 24, the EMA fraction of 24 wt % while the sum of Ionomer and Terpolymer (compatibilizers) was 8.4%. The fraction EMA divided by the sum of compatibilizers equals 2.9.

All of the example compositions in Table 3 were extruded without pressure surges and produced pellets of uniform dimensions.

To verify that the samples would not lump together under polyester drying conditions, samples of the impact modifier blend concentrates (27 g) were placed in a small aluminum pan and heated in air at 150° C. for two hours. Because the ethylene copolymers all have melting points of 90° C. or less, the pellets would be expected to fuse together at this temperature if the polyester were not the continuous phase, or at least a co-continuous phase. In all cases, however, it was possible to break the lumps into individual pellets after the heating cycle. In the case of Examples 22 and 26, it was more difficult to break up the pellets compared to the other examples.

### Example Set 4

Toughened polyester sheets were prepared from selected impact modifier blend concentrates. The proportions of concentrate and polyester were selected to produce sheet samples that contained 10 wt % of ethylene copolymer. Typical operating conditions for the sheet casting process are provided in Appendix 4. The sheet compositions are set forth in Table 4, below.

TABLE 4
Sheet Compositions

| | IMBC* | Amount | Amount of |
|---|---|---|---|
| Sheet | Example | of IMBC, | Polyester, |
| example | No. | wt % | Wt % |
| 1 | 20 | 25.5 | 74.5 |
| 2 | 22 | 20.0 | 80.0 |
| 3 | 24 | 29.5 | 70.5 |
| 4 | 25 | 20.9 | 79.1 |
| 5 | 26 | 16.7 | 83.3 |
| 6 | 27 | 30.3 | 69.7 |
| 7 | 28 | 20.8 | 79.2 |

*“IMBC” is an abbreviation of “impact modifier blend concentrate.”

To estimate the size of the dispersed phase particle size in the sheet, sheet samples were notched in the machine direction with a razor knife at room temperature. The sheet was subsequently annealed at 150° C. for three hours to crystallize the polyester fraction of the sheet. The notched and annealed sheet samples were then conditioned at −40° C. overnight. The sheet samples were removed from the freezer and flexed along the notched line to fracture the sheet into two pieces. One of these pieces was incubated in xylene for three hours at 50° C. to extract the ethylene copolymer phase from the polyester matrix. The extracted fracture surfaces were examined by scanning electron microscopy (SEM) at 500 and 5000 times magnification. This procedure is outlined in the Proceedings of the Antec conference of the Society of Plastics Engineers in a paper titled IMPACT MODIFICATION OF POLY(ETHYLENE TEREPHTHALATE) by N. Chapleau and M. A. Huneault (Antec 2001, Abstract #702).

The SEM images at 5000× magnification of sheet samples 1 to 7 reveal that sheet samples 1 and 2 have round or slightly oval holes left behind by the extraction of the dispersed phase. The size of the holes indicates an average particle diameter of 1 μm, with a few particles as large as 2μ. In sheet samples 6 and 7, the holes are round and less than 1 μm in diameter. In sheet samples 3, 4 and 5, the holes are elongated. The image from sheet sample 3 shows holes that are slightly elongated, generally small ovals uniformly less than 1 μm in longest axis. The image from sheet sample 4 shows holes where the elongation of the long axis is more pronounced. The average long axis length is over 1 μm and there is evidence of larger domains of ethylene copolymer up to 5 μ in diameter. The holes in sheet sample 5 are very elongated, and some elongated particles are over 2 μ in length. There is also evidence of large (5 μm diameter) holes in the sample. Table 5 includes a summary of the SEM analysis.

Sheet samples 1 to 7 were cut into 10 cm by 10 cm squares and annealed for three hours at 140° C. to crystallize the polyester component of the sheet. The squares were then conditioned at −40° C. overnight prior to dart drop testing according to ASTM D5628 geometry FA. From each sample sheet, approximately 25 squares were tested to arrive at an estimate of how much dart weight would be required for 50% of the sheet samples to fail when impacted at −40° C. from a drop height of 66 cm. Because sheet thickness influences the outcome, we have reported a normalized F50 in grams/25 μm. Table 5 summarizes the results of the dart drop testing of the annealed sheet samples.

TABLE 5
SEM Analysis and Results of ASTM D5628 Geometry FA

| | Impact | SEM sheet | Dispersed |
|---|---|---|---|
| | F50 | average | particle |
| sheet | (g/25 μm) | (μm) | Shape |
| 1 | 23 | 1 | Round |
| 2 | 28 | 1 | Round |
| 3 | 21 | 1 | Oval |
| 4 | 20 | 1.5 | Oval |
| 5 | 13 | 1.5-2 | Oval |
| 6 | 33 | <1 | Round |
| 7 | 24 | <1 | Round |

The results in Table 5 demonstrate that small particle size and a tendency towards spherical morphology correlate with superior toughness in polyester blends including the impact modifier blend concentrates of the invention.

### Appendices

Appendix 1

The polyester resins were dried overnight at 130° C. in a dessicant hopper dryer system. The dryer was built by the Conair Group, Inc. of Pittsburgh, Pa, and the hoppers were built by Thoreson McCosh, Inc., of Troy, Mich. The temperature set point of the dryer was lowered in the morning to 65° C., and after one hour the ethylene copolymer and compatibilizers were added to separate compartments of the dryer and dried for at least two hours. After drying, weighed amounts of compatibilizer, ethylene copolymer, polyester, and antioxidant were blended by shaking in a bag for 30 seconds. The resulting 3.5 kg batches of pellet blends were fed to the throat (Barrel 1) of a 25 mm 38/1 L/D ZSK-25 World Lab twin-screw extruder manufactured by Krupp Werner & Pfleiderer Lebensmitteltechnik GmbH of Dinkelsbuehl, Germany.

The melt blend exiting the extruder through a two-hole die was quenched in water. The quenched strand was cut into pellets using a pelletizer available from C. F. Scheer of Stuttgart, Germany. Typical operating conditions (actual conditions for Example 4) are shown in Table A1.

TABLE A1
Operating Conditions During Extrusion Compounding

| | Temperature | Actual |
|---|---|---|
| | Set Point, ° C. | Temperature, ° C. |
| Temperature Control Zone 1 | 280 | 280 |
| (Barrel Zones 2 and 3) | | |
| Temperature Control Zone 2 | 280 | 280 |
| (Barrel Zones 4 and 5) | | |
| Temperature Control Zone 3 | 270 | 270 |
| (Barrel Zones 6 and 7) | | |
| Temperature Control Zone 4 | 260 | 262 |
| (Barrel Zones 8 and 9) | | |
| Temperature Control Zone 5 | 260 | 260 |
| (Die) | | |
| Screw Speed (rpm) | | 350 |
| Torque (%) | | 39 |
| Die Pressure (kPa) | | 883 |
| Melt Temperature (° C.) | | 284 |
| Total Throughput (g/min) | | 160 |
| Sheer Cutter Set-point | | 16 |
| Vacuum Zone 4 (mmHg) | | 29 |

Appendix 2

The Elvaloy® 1224AC (EMA 1) and the organic peroxide, 2,5-dimethyl-2,5-Di-(t-butylperoxy)hexane, were fed into the throat (Barrel 1) of the extruder. Because the peroxide is a liquid at room temperature, it was first coated onto the surface of a portion of the EMA using a drum blender, resulting in a concentrate of peroxide on EMA with a nominal peroxide loading of 1.5 wt %. Two K-Tron loss in weight feeders, available from the K-Tron Feeder Group of Pitman, N.J., were used to meter the peroxide concentrate and EMA 1 into the throat of the extruder. The peroxide concentrate was fed at 326 g/min and EMA 1 was fed at 1091 g/min.

Extruder operating conditions for the preparation of EMA 3 are set forth in detail in Table A2.

TABLE A2
Extruder Operating Conditions

| | Temperature | Actual |
|---|---|---|
| | Set Point, ° C. | Temperature, ° C. |
| Barrel 2 | 120 | 119 |
| Barrel 3 | 150 | 150 |
| Barrel 4 | 200 | 199 |
| Barrel 5 | 210 | 208 |
| Barrel 6 | 210 | 210 |
| Barrel 7 | 210 | 209 |
| Barrel 8 | 210 | 225 |
| Barrel 9 | 210 | 209 |
| Barrel 10 | 210 | 209 |
| Barrel 11 | 210 | 210 |
| Barrel 12 | 210 | 209 |
| Die | 210 | 211 |
| Melt Temp at Gala | | 240 |
| Die Pressure at Gala (kPa) | | 5330 |
| Screw Speed (rpm) | | 350 |
| Extruder Torque (amps) | | 30 |
| Torque (% of maximum) | | 60 |
| Melt Temperature Barrel 7 (° C.) | | 242 |
| Total Throughput (g/min) | | 1409 |
| Gala Cutter Open Holes | | 11 |
| Gala Speed (rpm) | | 13468 |
| Vacuum Barrel 11 (mmHg) | | 27 |

Appendix 3

The polyester resins were dried overnight at 130° C. in a dessicant hopper dryer system using the equipment described above at Appendix 1. The compatibilizer and the ethylene copolymer were not dried prior to extrusion. In this case the compatibilizer or blend of compatibilizers was preblended with the antioxidant in a large drum blender, typically in 35 kg batches. The resulting pellet blend was fed into Barrel 1 of the twin-screw extruder using a K-Tron loss in weight feeder. A second loss in weight feeder metered the dried polyester resin, also into Barrel 1. Typical operating conditions (actual conditions for fabrication of Example 28) are shown in Table A3.

TABLE A3
Extruder Operating Conditions

| | Temperature | Actual |
|---|---|---|
| | Set Point, ° C. | Temperature, ° C. |
| Barrel 2 | 250 | 243 |
| Barrel 3 | 250 | 249 |
| Barrel 4 | 280 | 281 |
| Barrel 5 | 280 | 280 |
| Barrel 6 | 280 | 274 |
| Barrel 7 | 280 | 274 |
| Barrel 8 | 280 | 317 |
| Barrel 9 | 280 | 311 |
| Barrel 10 | 265 | 264 |
| Barrel 11 | 265 | 266 |
| Barrel 12 | 265 | 266 |
| Die | 285 | 282 |
| Melt Temp at Gala | | 302 |
| Feeder (0.95V PET) g/min | | 420 |
| Feeder (Blend of Ethylene | | 388 |
| Copolymers and AO) | | |
| Die Pressure at Gala (kPa) | | 4275 |
| Screw Speed (rpm) | | 350 |
| Extruder Torque (amps) | | 27 |
| Torque (% of maximum) | | 48 |
| Melt Temperature Barrel 7 (° C.) | | 315 |
| Total Throughput (g/min) | | 806 |
| Gala Cutter Open Holes (diameter | | 11 (3.8) |
| of hole mm) | | |
| Gala Speed (rpm) | | 14737 |
| Vacuum Barrel 11 (mmHg) | | 27.4 |

Appendix 4

The polyester resin and example concentrates were dried separately overnight at 130° C. in a dessicant hopper dryer system using the equipment described above at appendix 1. The polyester and example concentrate were removed from the drier and blended by hand in the proportions outlined in Table 4 to make up a 3500 g batch of pellet blend that was immediately charged to the throat (Barrel 1) of the single screw extruder through a nitrogen swept hopper. The extruder was a 31.75 mm diameter 30/1 L/D model fitted with a 3/1 compression ratio, single flighted screw with 5 L/D of a melt mixing section. The extruder die was a 203 mm wide coat hanger type flat film die with a 0.8 mm die gap. The extruder was built by Wayne Machine of Totowa, N.J. The molten polymer film exiting from the die drawn down to nominally 0.7 mm thick as it was cast onto a 203 mm wide by 203 mm diameter double shell spiral baffle casting roll fitted with controlled temperature cooling water. The casting roll and 203 mm wide die were built by Killion Extruders—Davis Standard of Cedar Grove, N.J. Typical operating conditions for sheet extrusion (actual conditions for fabrication of Sheet 7) are shown in Table A4.

TABLE A4
Extruder Operating Conditions

| | Temperature | Actual |
|---|---|---|
| | Set Point, ° C. | Temperature, ° C. |
| Barrel Zone 1 | 295 | 295 |
| Barrel Zone 2 | 295 | 295 |
| Barrel Zone 3 | 280 | 279 |
| Barrel Zone 4 | 280 | 280 |
| Filter Flange | 280 | 280 |
| Adapter | 280 | 280 |
| End Plates on Die | 280 | 281 |
| Die Face | 290 | 291 |
| Filter Melt | | 276 |
| Adapter Melt | | 290 |
| Filter Pressure (kPa) | | 7171 |
| Adapter Pressure (kPa) | | 3930 |
| Screw R.P.M. | | 100 |
| Screw Torque (Amps) | | 3 |
| CASTING UNIT | | |
| Casting Roll - meters per | | 1.62 |
| minute | | |
| Haul Off Roll ratio (speed | | 1.01 |
| relative to casting roll) | | |
| Casting Roll Nip - (kPa) | | 414 |
| Film Gauge (mm) | | 0.711 |
| Layflat (cm) | | 18.5 |
| Throughput (gm/min) | | 264 |
| H₂O Recirculation Unit (water | | |
| to Casting and Nip Rolls) | | |
| Temperature Set/Actual T (° C.) | 49 | 47 |

While certain of the preferred embodiments of the present invention have been described and specifically exemplified above, it is not intended that the invention be limited to such embodiments. Various modifications may be made without departing from the scope and spirit of the present invention, as set forth in the following claims.

1. An impact modifier blend concentrate composition comprising
a. a polyester; and
b. an ethylene copolymer blend comprising an ethylene alkyl acrylate copolymer selected from the group consisting of copolymers of ethylene with one or more alkyl acrylates wherein the alkyl group is a straight chain or branched group having from one to ten carbon atoms; and a compatibilizer, said compatibilizer comprising an ionomer;
wherein the polyester is present in an amount less than about 75 wt % and the ethylene copolymer blend is present in an amount greater than about 25 wt %, based on the total weight of the impact modifier blend concentrate.

2. The impact modifier blend concentrate composition of claim 1, wherein the polyester is selected from the group consisting of polyethylene terephthalate; polyethylene terephthalate that incorporates isophthalic acid or cyclohexane dimethanol; copolymers of terephthalic acid, cyclohexane dimethanol and isophthalic acid; polyethylene naphthalate; copolyesters thereof; combinations thereof; and derivatives thereof.

3. The impact modifier blend concentrate composition of claim 1, wherein the polyester comprises polyethylene terephthalate.

4. The impact modifier blend concentrate composition of claim 1, wherein the amount of polyester ranges from about 40 to about 75 wt %, and wherein the amount of ethylene copolymer blend ranges from about 25 to about 60 wt %, based on the total weight of the impact modifier blend concentrate.

5. The impact modifier blend concentrate composition of claim 1, wherein the amount of polyester ranges from about 55 to about 70 wt %, and wherein the amount of ethylene copolymer blend ranges from about 30 to about 45 wt %, based on the total weight of the impact modifier blend concentrate.

6. The impact modifier blend concentrate composition of claim 1, wherein the ratio of the weight of the ethylene alkyl acrylate copolymer to the weight of the compatibilizer ranges from about 3:1 to about 6:1.

7. The impact modifier blend concentrate composition of claim 1, wherein the polyester forms a continuous phase.

8. The impact modifier blend concentrate composition of claim 1, wherein the ethylene alkyl acrylate copolymer has a melt flow index less than 1 g/10 min when measured at 190° C. with 2.16 kg weight.

9. The impact modifier blend concentrate composition of claim 1, wherein the ethylene alkyl acrylate copolymer has a melt flow index less than 0.5 g/10 min when measured at 190° C. with 2.16 kg weight.

10. The impact modifier blend concentrate composition of claim 1, wherein the ionomer comprises a copolymer of ethylene and methacrylic acid or a copolymer of ethylene, methacrylic acid, and an alkyl methacrylate, and wherein the ionomer is at least partially neutralized with sodium ions.

11. The impact modifier blend concentrate composition of claim 1, further comprising a crosslinking agent.

12. The impact modifier blend concentrate composition of claim 11, wherein the crosslinking agent comprises one or more of diethylene glycol diacrylate, diethylene glycol dimethacrylate, ethylene glycol dimethacrylate, N,N′-m-phenylene dimaleimide, polyethylene glycol dimethacrylate, triallyl cyanurate, triallylisocyanurate, trimethylolpropane trimethacrylate, tetraallyloxyethane, tetramethylene diacrylate, 2,5-dimethyl-2,5-di-(t-butylperoxy)hexyne-3, t-butyl peroxybenzoate, 2,5-dimethyl-2,5-di-(t-butylperoxy)-2,5-dimethylhexane, dicumyl peroxide, copolymers of ethylene with maleic acid or anhydride, and α,α-bis(t-butylperoxy)-2,5-dimethylhexane.

13. The impact modifier blend concentrate composition of claim 12, wherein the crosslinking agent comprises diethylene glycol dimethacrylate, 2,5-dimethyl-2,5-di-(t-butylperoxy)hexane, or a combination of both diethylene glycol dimethacrylate and 2,5-dimethyl-2,5-di-(t-butylperoxy)hexane.

14. An article comprising a bulk polyester and the impact modifier blend concentrate composition of any of claims 1 through 13.

15. The article of claim 14, wherein the bulk polyester is selected from the group consisting of polyethylene terephthalate; polyethylene terephthalate that incorporates isophthalic acid or cyclohexane dimethanol; copolymers of terephthalic acid, cyclohexane dimethanol and isophthalic acid; polyethylene naphthalate; copolyesters thereof; combinations thereof; and derivatives thereof.

16. The article of claim 14, wherein the bulk polyester comprises polyethylene terephthalate.

17. The article of claim 14, wherein the bulk polyester comprises recycled polyester.

18. The article of claim 14, wherein the amount of the impact modifier blend concentrate composition ranges from about 10 wt % to about 40 wt %, based on the combined weight of the bulk polyester and the impact modifier blend concentrate composition.

19. The article of claim 14, wherein the ethylene copolymer blend forms a dispersed phase that is particulate, and further wherein the particle size is less than or equal to about 2 μm.

20. The article of claim 14, being a dual ovenable tray.

21. A method of making an impact modifier blend concentrate composition comprising the steps of
reacting an ethylene alkyl acrylate copolymer said ethylene acrylate copolymer selected from the group consisting of copolymers of ethylene with one or more alkyl acrylates wherein the alkyl group is a straight chain or branched group having from one to ten carbon atoms, and a crosslinking agent to produce a higher molecular weight ethylene alkyl acrylate copolymer;
combining the higher molecular weight ethylene alkyl acrylate copolymer with a compatibilizer comprising an ionomer to produce an ethylene copolymer blend; and
combining the ethylene copolymer blend with a polyester.

22. The method of claim 21, wherein the higher molecular weight ethylene alkyl acrylate has a melt index less than or equal to 0.3 g/10 min when measured according to ASTM D1238.

23. The method of claim 21, wherein the ethylene alkyl acrylate and the crosslinking agent are reacted in an extruder.

24. The method of claim 21, wherein the crosslinking agent comprises one or more of diethylene glycol diacrylate, diethylene glycol dimethacrylate, ethylene glycol dimethacrylate, N, N′-m-phenylene dimaleimide, polyethylene glycol dimethacrylate, triallyl cyanurate, triallylisocyanurate, trimethylolpropane trimethacrylate, tetraallyloxyethane, tetramethylene diacrylate, 2,5-dimethyl-2,5-di-(t-butylperoxy)hexyne-3, t-butyl peroxybenzoate, 2,5-dimethyl-2,5-di-(t-butylperoxy)-2,5dimethylhexane, dicumyl peroxide, copolymers of ethylene with maleic acid or anhydride, and α,α-bis(t-butylperoxy)-2,5-dimethylhexane.

25. The method of claim 24, wherein the crosslinking agent comprises diethylene glycol dimethacrylate, 2,5-dimethyl-2,5-di-(t-butylperoxy)hexane, or a combination of both diethylene glycol dimethacrylate and 2,5-dimethyl-2,5-di-(t-butylperoxy)hexane.

26. A method of making an impact resistant polyester, said method comprising the steps of
a. providing an impact modifier blend concentrate comprising,
i. a polyester; and
ii. an ethylene copolymer blend comprising an ethylene alkyl acrylate copolymer selected from the group consisting of copolymers of ethylene with one or more alkyl acrylates wherein the alkyl group is a straight chain or branched group having from one to ten carbon atoms; and a compatibilizer, said compatibilizer comprising an ionomer;
wherein the polyester is present in an amount less than about 75 wt % and the ethylene copolymer blend is present in an amount greater than about 25 wt %, based on the total weight of the impact modifier blend concentrate; and
b. combining the impact modifier blend concentrate with a bulk polyester.

27. The method of claim 26, wherein the polyester or the bulk polyester is selected from the group consisting of polyethylene terephthalate; polyethylene terephthalate that incorporates isophthalic acid or cyclohexane dimethanol; copolymers of terephthalic acid, cyclohexane dimethanol and isophthalic acid; polyethylene naphthalate; copolyesters thereof; combinations thereof; and derivatives thereof.

28. The method of claim 26, wherein the polyester or the bulk polyester comprises polyethylene terephthalate.

29. The method of claim 26, wherein the bulk polyester comprises recycled polyester.

30. The method of claim 26, wherein the impact modifier blend concentrate composition and the bulk polyester are combined by extrusion.

31. The method of claim 26, wherein the impact modifier blend concentrate further comprises a crosslinking agent; and further comprising the steps of
reacting the ethylene alkyl acrylate and the crosslinking agent to produce a higher molecular weight ethylene alkyl acrylate; combining the higher molecular weight ethylene alkyl acrylate with a compatibilizer comprising an ionomer to produce an ethylene copolymer blend; and
combining the ethylene copolymer blend with a polyester to produce the impact modifier blend concentrate.

32. The method of claim 26, further comprising the step of drying the bulk polyester, the impact modifier blend concentrate composition, or both the bulk polyester and the impact modifier blend concentrate composition prior to combining the impact modifier blend concentrate composition with the bulk polyester or prior to extruding the impact modifier blend concentrate composition with the bulk polyester.

33. An impact resistant polyester obtainable by the method of any of claims 26 through 32.

34. The impact resistant polyester of claim 33, wherein the ethylene copolymer blend forms a dispersed phase that is particulate, and further wherein the particle size is less than or equal to about 2 μm.

35. A method of making an impact resistant article, said method comprising the steps of
a. providing an impact modifier blend concentrate composition comprising
i. a polyester; and
ii. an ethylene copolymer blend comprising an ethylene alkyl acrylate copolymer selected from the group consisting of copolymers of ethylene with one or more alkyl acrylates wherein the alkyl group is a straight chain or branched group having from one to ten carbon atoms; and a compatibilizer, said compatibilizer comprising an ionomer;
wherein the polyester is present in an amount less than about 75 wt % and the ethylene copolymer blend is present in an amount greater than about 25 wt %, based on the total weight of the impact modifier blend concentrate; and
b. combining the impact modifier blend concentrate composition with a bulk polyester; and
c. forming the impact resistant article from the impact modifier blend concentrate composition and the bulk polyester.

36. The method of claim 35, wherein the polyester or the bulk polyester is selected from the group consisting of polyethylene terephthalate; polyethylene terephthalate that incorporates isophthallc acid or cyclohexane dimethanol; copolymers of terephthalic acid, cyclohexane dimethanol and isophthalic acid; polyethylene naphthalate; copolyesters thereof ; combinations thereof; and derivatives thereof.

37. The method of claim 35, wherein the polyester or the bulk polyester comprises polyethylene terephthalate.

38. The method of claim 35, wherein the bulk polyester comprises recycled polyester.

39. The method of claim 35, wherein the ethylene copolymer blend further comprises a crosslinking agent.

40. The method of claim 39, wherein the crosslinking agent comprises one or more of diethylene glycol diacrylate, diethylene glycol dimethacrylate, ethylene glycol dimethacrylate, N,N′-m-phenylene dimaleimide, polyethylene glycol dimethacrylate, triallyl cyanurate, triallylisocyanurate, trimethylolpropane trimethacrylate, tetraallyloxyethane. tetramethylene diacrylate, 2,5-dimethyl-2,5di-(t-butylperoxy)hexyne-3, t-butyl peroxybenzoate, 2,5-dimethyl-2,5-di-(t-butylperoxy)-2,5-dimethylhexane, dicumyl peroxide, copolymers of ethylene with maleic acid or anhydride, and α,α-bis(t-butylperoxy)-2,5-dimethylhexane.

41. The method of claim 40, wherein the crosslinking agent comprises diethylene glycol dimethacrylate, 2,5-dimethyl-2,5-di-(t-butylperoxy)hexane, or a combination of both diethylene glycol dimethacrylate and 2,5-dimethyl-2,5-di-(t-butylperoxy)hexane.

42. The method of claim 39, wherein the impact modifier blend concentrate further comprises a crosslinking agent; and further comprising the steps of
reacting the ethylene alkyl acrylate and the crosslinking agent to produce a higher molecular weight ethylene alkyl acrylate; combining the higher molecular weight ethylene alkyl acrylate with a compatibilizer comprising an ionomer to produce an ethylene copolymer blend; and
combining the ethylene copolymer blend with a polyester to produce the impact modifier blend concentrate.

43. The method of claim 35, wherein the impact modifier blend concentrate composition and the bulk polyester are combined by extrusion.

44. The method of claim 35, further comprising the step of drying the bulk polyester, the impact modifier blend concentrate composition, or both the bulk polyester and the impact modifier blend concentrate composition prior to combining the impact modifier blend concentrate composition with the bulk polyester or prior to extruding the impact modifier blend concentrate composition with the bulk polyester.

45. An article obtainable by the method of any of claims 35 through 44.

46. The article of claim 45, wherein the ethylene copolymer blend forms a dispersed phase that is particulate, and further wherein the particle size is less than or equal to about 2 μm.

47. The article of claim 45, being a dual ovenable tray.
